(19) United States
(12) Patent Application Publication
(10) Pub. No.: US 2020/0158557 A1
(43) Pub. Date: May 21, 2020

(54) ADJUSTABLE MEASUREMENT SLEEVE FOR DETERMINING THE AMOUNT OF FLUID PASSING THROUGH A DUCT

(71) Applicant: OXEAU INVEST, Bordeaux (FR)

(72) Inventor: Jacques LE FLOC'H, ST ROMAIN (FR)

(21) Appl. No.: 16/314,462

(22) PCT Filed: Jul. 3, 2017
(86) PCT No.: PCT/FR2017/051796

§ 371 Date: Dec. 31, 2018

(30) Foreign Application Priority Data
Jul. 1, 2016 (FR) 1656325

(51) Int. Cl. G01F 25/00; G01F 1/38

(52) U.S. Cl. CPC G01F 25/0007; G01F 1/383

(57) ABSTRACT

A measurement sleeve for determining the amount of fluid passing through a duct, wherein the sleeve, designed to be fitted around a fluid duct, comprises a first part and a second part interconnected to define an accommodating space for the duct in addition to an electromechanical sensor arranged on one of the parts so as to be applied against the outside wall of the duct, wherein the measurement sleeve comprises calibrated adjustment means for adjusting the accommodating space according to separate predefined diameters so as to apply an appropriate predetermined pressure to the sensor regardless of the dimensions of the duct, with each predefined diameter corresponding to a duct of a specific diameter.

### BACKGROUND OF THE INVENTION

The invention relates to the field of metrology and more specifically that of measuring the amount of fluid flowing through a duct.

The invention relates more specifically to a measurement sleeve for determining the amount of fluid passing through a duct, wherein said sleeve, designed to be fitted around a fluid duct, comprises a first part and a second part interconnected to define a space for accommodating the duct and an electromechanical sensor arranged on one of the parts so as to have a portion extending in the space for accommodating the duct.

The measurement sleeve is intended in particular, but not exclusively, for the purposes of analysing and characterising consumption of a fluid, particularly water or a liquid, circulating in a duct.

Patent application WO2014/020252 discloses a measurement sleeve designed to be fitted around a supply pipe for the purposes of acquiring signals with a view to estimating individual water consumption of a plurality of devices. The sleeve comprises an electromechanical sensor applied against the outside wall of said supply pipe, in addition to a processor for analysing the signals delivered by said electromechanical sensor with a view to extracting information characterising the individual consumption of at least some of the devices supplied by said secondary network.

The sleeve consists of two tubular half-shells connected by a joint allowing its opening with a view to insertion around a pipe, as well as its closure with a view to application of said sensor against the wall of said pipe. The two half-shells are locked together by means of a locking spoiler borne by one of the half-shells, said spoiler being designed to interact with a complementary spoiler borne by the other half-shell.

The measurement sleeve of the above-mentioned patent application has however the disadvantage of not providing the same accuracy in terms of measurements according to the pipe on which it is to be mounted. Indeed, depending on the diameter of the pipes, the pressure applied by the outside wall of the pipe on the sensor may vary according to the diameter of the latter. It will be readily understood that a pipe with a diameter larger than that of another pipe will exert greater pressure on the sensor than a pipe with a smaller diameter. Furthermore, the measurement sleeve remains dedicated to pipes of a certain diameter. However, too much pressure or too little pressure may cause errors in reading the measurements by the sensor.

The invention aims to solve these problems by providing a measurement sleeve and a system comprising such a measurement sleeve ensuring optimum pressure of the duct on the electromechanical sensor, regardless of the dimensions of the duct on which it is mounted.

The invention also aims to provide a measurement sleeve capable of being mounted quickly and easily on the duct to be assessed while ensuring application of an appropriate pressure on the sensor by the duct, regardless of the dimensions of the duct.

The invention also aims to avoid transmitting vibrations into the mass of the sleeve during passage of fluid through the duct.

The invention also aims to provide a measurement sleeve that is adjustable according to the type of duct to be assessed.

### SUMMARY OF THE INVENTION

For this purpose, and according to a first aspect, the invention provides a measurement sleeve for determining the amount of fluid passing through a duct, wherein said sleeve, designed to be fitted around a fluid duct, comprises a first part and a second part interconnected to define a space for accommodating the duct and an electromechanical sensor arranged on one of the parts so as to be applied against the outside wall of the duct, said measurement sleeve being remarkable in that it comprises calibrated adjustment means for adjusting the accommodating space according to separate predefined diameters so as to apply an appropriate predetermined pressure to the sensor regardless of the dimensions of the duct, with each predefined diameter corresponding to a duct of a specific diameter.

Hence, owing to the presence of calibrated means of adjustment of the accommodating space, clamping of the duct is optimally performed so as to correspond jointly (i) to the diameter and advantageously, to the nature of the duct in question and (ii) to the characteristics required for measurement by the electromechanical sensor by applying an adequate pressure to said sensor while limiting the risks of damage to the latter. The opening of the accommodating space being thus pre-established (or pre-calibrated) for ducts of given diameter and if necessary of a given type, mounting of the measurement sleeve on the duct in question is carried out quickly and easily while ensuring application of an appropriate pressure to the sensor regardless of the dimensions of the duct. Appropriate pressure means a pressure that takes account of the sensor employed on the one hand and which is constant, i.e. identical—for all the ducts on which the sleeve is mounted—on the other hand.

Advantageously, the sensor is integral with a piston capable of travelling between a position in which the piston has a portion protruding into the accommodating space and a position in which the piston is flush with the inside wall of the part in which it is arranged. The protruding position of the piston defines the piston position initially before the sleeve is clamped on the duct, with movement from the protruding position to the flush position of the piston being obtained by clamping the sleeve around the duct via the calibrated adjustment means.

Advantageously, the piston is held in the protruding position in the accommodating space before clamping by means of an element forming a spring, of the O-ring type. After clamping, the piston is held in elastic abutment against the outside wall of the duct in a position flush with the inside wall of the part in question. This elastic abutment combined with clamping of the parts of the sleeve against the duct via the calibrated adjustment means offers the advantage of ensuring optimum vibration of the electromechanical sensor. Indeed, it is once the piston abuts against the duct and is positioned flush in relation to the part in question owing to the elasticity of the O-ring and the pre-calibration of the rigid clamping of the sleeve that the latter exerts the appropriate pressure on the sensor and transmits the vibrations to the latter without any repercussion or diffusion of vibration into the mass of the sleeve. The piston thus constitutes a member for transmitting the vibrations to the sensor.

Advantageously, the adjustment means comprise a rack borne by one of the parts, the other part being provided with a lug capable of engaging with a notch in the rack, said rack comprising a plurality of notches arranged to define, with the lug engaged, accommodating spaces suitable for receiving respectively a duct of a given diameter while jointly ensuring the application of the same pressure to the electromechanical sensor regardless of the diameter of the duct on which the sleeve is mounted.

Advantageously, the sleeve comprises means of adjusting the load pressure exerted on the duct by the piston.

Advantageously, the sleeve comprises an interchangeable element made of expanded material, of uniform thickness, designed to be interposed between one of the parts and the fluid duct such that when the measurement sleeve is mounted and clamped on the fluid duct, the piston exerts a pressure adapted to the fluid duct.

Advantageously, the electromechanical sensor is arranged on one of the parts with clearance so as to allow movement of the sensor in a direction perpendicular to the longitudinal axis of the accommodating space.

Advantageously, the electromechanical sensor is integral with an electrically conductive element bearing the piston.

Advantageously, the electromechanical sensor is arranged between two wedging elements, with one of the wedging elements forming the piston and each wedging element comprising a contact portion capable of being placed in contact with an electrical contact pin. According to a particular configuration, the electrical contact pins can be provided so as to be accommodated in a third part fixed to the part comprising the electromechanical sensor.

Advantageously, the electromechanical sensor is accommodated in the wall of one of the parts.

Advantageously, the electromechanical sensor is a piezoelectric sensor.

Advantageously, the sleeve comprises a single electromechanical sensor.

The invention also relates to equipment for determining the amount of fluid passing through a duct, comprising a measurement sleeve as described above in addition to a series of interchangeable elements, made of expanded material, of a different type and/or thicknesses.

### BRIEF DESCRIPTION OF THE DRAWINGS

Further objectives and advantages of the invention will become apparent from the following description made in reference to the appended drawings, wherein:

FIG. 1 illustrates a perspective view of a measurement sleeve according to a first embodiment of the invention;

FIG. 2 illustrates a cross-sectional view of the measurement sleeve in FIG. 1;

FIG. 3 illustrates a longitudinal sectional view of the measurement sleeve in FIG. 1;

FIG. 4 illustrates a detailed view of the measurement sleeve in FIG. 3;

FIG. 5 illustrates a perspective view of a measurement sleeve topped by an electronic box according to a second embodiment of the invention;

FIG. 6 illustrates a longitudinal sectional view of the measurement sleeve in FIG. 5;

FIGS. 7 and 8 illustrate a front and rear view of the measurement sleeve in FIG. 5, with the electronic box being illustrated not mounted on the sleeve;

FIG. 9 illustrates a perspective view of a measurement sleeve topped by an electronic box according to another embodiment of the invention;

FIG. 10 illustrates a cross-sectional view of the measurement sleeve in FIG. 9.

For greater clarity, identical or similar elements of the different embodiments are marked by identical reference signs on all the figures.

### DETAILED DESCRIPTION

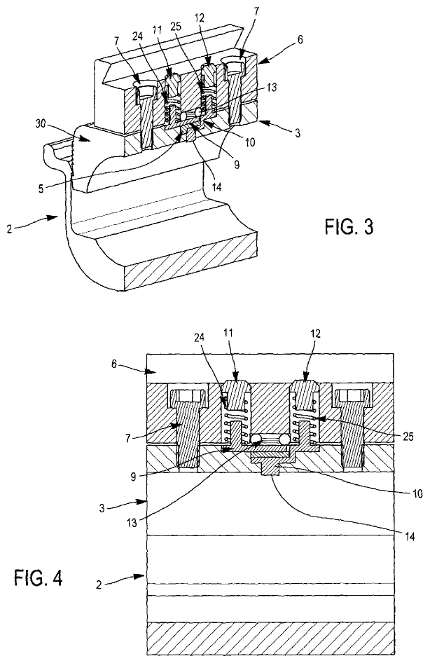

In relation with FIGS. 1 to 4, a measurement sleeve 1 for determining the amount of fluid passing through a duct is described. The measurement sleeve 1 is designed to be fitted around a fluid duct through which the fluid passes, the quantity of which is to be determined.

The measurement sleeve 1 comprises two semi-tubular parts arranged and coupled together to define a space extending from the end of the measurement sleeve 1 to the other end. The space forms an accommodating space 7 for the fluid duct. The semi-tubular parts will be referred to hereafter a bottom part 2 and top part 3 in relation to the measurement sleeve shown in the figures.

The two parts 2, 3 are coupled together by reciprocal association means that comprise, in the embodiment shown, a rack device 4. More specifically, one of the parts, in the present case the top part 3, comprises a series of parallel notches 40 extending longitudinally over all or part of the outer face of the side walls 31, 32, whereas the bottom part 2 comprises one or more lug(s) 41 arranged on the inner face 210, 220 of each side wall 21, 22 and extending completely or partly along said side wall, said lugs being capable of interacting with the notches of the rack. The outer face of a wall means the side facing away from the accommodating space 7 and inner face of a wall means the side facing towards the accommodating space. It is evidently understood that the invention is not restricted to this configuration and their arrangement can be reversed (notches and lug on the inside and outside respectively, notch and lug borne respectively by the bottom part 2 and top part 3).

The lugs 40 borne by each of the side walls are spaced apart so as to define openings, each corresponding to a duct of a specific diameter (or specific height for a duct other than circular in section), but adjusted to ensure clamping of the duct so as to apply, to an effort measurement sensor of an electromechanical measurement system described below, a predetermined pressure, identical for each of the ducts referenced by the notches. The sleeve thus has pre-calibrated openings for fluid ducts of a given diameter, and if appropriate of a given type. This therefore ensures application of identical pressure to the effort measurement sensor and moreover regardless of the dimensions and type of the duct on which the sleeve is mounted.

In order to record the amount of fluid passing through the fluid duct, the measurement sleeve 1 is combined with an electromechanical measurement system based on use of at least one electromechanical sensor 5. In the embodiment illustrated, the electromechanical measurement system is partly accommodated in a cavity arranged in the base wall 30 of the top part 3, another part being accommodated in a third part 6, hereinafter known as a cover, fixed to the upper surface of the base wall. In the embodiment illustrated, the cover 6 is fixed to the top part 3 by means of two retaining screws 7 arranged in the vicinity of the ends of the cover 6. The cover 6 is advantageously provided with a dovetailed longitudinal groove 8 designed to receive an electronic box (not illustrated) having a base of a shape complementary to the dovetail, said base being slidably mounted along the groove 8. The electronic box contains an electronic circuit for pre-processing the signals received from the electromechanical sensor, which are transmitted to a remote processor via a wired or wireless link, according to Wifi standard for example. It can also be provided that the received signals are also recorded in a local memory allowing a reading from a device via a USB port or using a memory card such as a SIM card for example.

In the embodiment illustrated, the electromechanical sensor 5, advantageously a piezoelectric sensor, is accommodated in the cavity in the base wall 30 of the part 3. It is arranged between two electrical wedging elements 9, 10, with one of the elements defining a top wedging element 9 and the other a bottom wedging element 10. Each wedging element 9, 10 comprises a portion capable of being placed in contact respectively with an electrical contact pin 11, 12. In the embodiment illustrated, contact between the wedging elements 9, 10 and one of the contact pins 11, 12 is established via a compression spring 24, 25 respectively. Provision may of course be made for other arrangements without going beyond the ambit of the invention. Provision may be made in particular for an arrangement comprising a single wedging element, the bottom wedging element 10, on which the sensor is mounted. In this case, the wedging element 10 will comprise portions capable of being placed in contact with each of the electrical contact pins.

The assembly formed of the electromagnetic sensor 5 and wedging elements 9, 10 is arranged in the top part 3, inside the cavity, with clearance allowing movement of the sensor in a direction perpendicular to the longitudinal axis of the accommodating space 7.

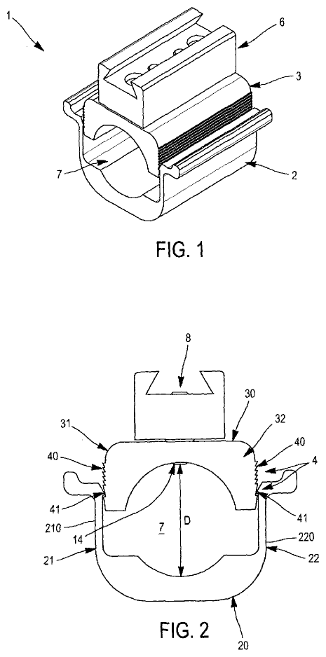

The assembly formed of the electromagnetic sensor 5 and wedging elements 9, 10 is furthermore integral with a member, hereinafter referred to as a piston, capable of moving inside the cavity between a position in which said piston has a protruding portion 14 protruding in relation to the inside wall of the part 3 into the accommodating space 7 and a position in which said piston is flush with the inside wall of the part 3. The protruding position 14 of the piston, illustrated in FIGS. 2 to 4, corresponds to the piston position before clamping on the duct, while the flush position of the piston (position not illustrated) corresponds to the piston position after clamping of the sleeve around the duct, said clamping being adapted to the diameter of the duct and if appropriate, to the type of the latter in addition to the type of electromechanical sensor via the pre-calibrated reciprocal association means (rack device).

Advantageously, the piston is held in the protruding position in the accommodating space 7 before the sleeve is clamped around the duct by means of a compression O-ring 13. The O-ring 13 is accommodated in a space that opens out at the bottom of the cover 6, in alignment with the sensor/wedging elements assembly.

Presence of the compression O-ring 13 and its arrangement with the electromechanical measurement system thus makes it possible to guarantee, in addition to airtightness between the cover 6 and the top part 3, adequate support on the duct to ensure appropriate pressure for transmitting the vibrations to the single electromagnetic sensor 5. Furthermore, maintaining the piston in elastic abutment against the outside wall of the duct, combined with clamping of the parts of the sleeve against the duct via the calibrated adjustment means offers the advantage of ensuring optimum vibration of the electromechanical sensor. Indeed, only the piston, via the contact rendered flush with the duct after clamping and owing to the rigid hold of the sleeve, transmits the vibrations. Consequently, there is no repercussion or diffusion of vibration into the mass of the sleeve.

In the example illustrated, the piston and the wedging element 10 are formed in one piece.

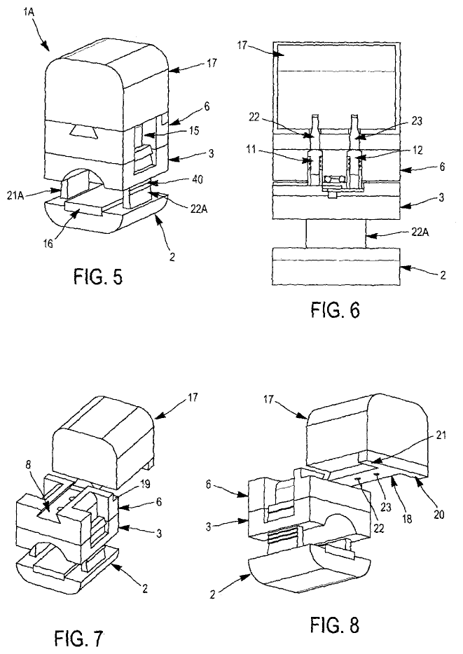

In addition to adjustment of the opening diameter, the measurement sleeve may include means to adjust the load pressure exerted on the duct by the protruding portion of the piston and more specifically the protruding portion 14 of the bottom wedging element 10. Such means will be described with the exemplary embodiments illustrated in FIGS. 5 to 10 described below.

FIGS. 5 to 8 illustrate an alternative embodiment of a measurement sleeve 1A according to the invention shown, equipped with an electronic box 17.

The measurement sleeve 1A repeats on the whole the characteristics of the measurement sleeve 1 described previously. In particular, it comprises an arrangement of the electromechanical measuring system similar to that previously described as illustrated in FIG. 5, which shows the wedging elements in contact with the electrical contact pins 11, 12, themselves in contact with the electrical contact pins 22, 23 borne by the electronic box 17. As shown in FIGS. 7 and 8, the electronic box 17 has a base with a longitudinally extending tongue 18, which is complementary in shape to the dovetailed longitudinal groove 8. The end of the tongue 18 is prolonged by two transverse arms 20, 21, designed to abut against a shoulder 19 provided for this purpose on the cover 6.

In this exemplary embodiment however, the notches 40 are borne by the bottom portion 2, on the outer face of lateral arms 21A, 22A extending vertically, whereas the lugs 41 are borne by the top part 3, on the inner face side of the side walls 31A, 32A, which respectively have a vertical passage slot 15 for the passage of lateral arms 21A, 22A of the bottom portion 2 when coupling the parts together.

In addition to adjustment of the opening diameter, the measurement sleeve 1A includes means to adjust the load pressure exerted on the duct by the piston borne by the bottom wedging element 10. The adjustment means comprise an element made of expanded material 16 in the form of a flat layer, the thickness of which is regular. The element made of expanded material 16 is placed on the inner face of the base wall of the bottom part 2, so as to be interposed between the bottom part 2 and the fluid duct when the sleeve is in position on the latter.

The element made of expanded material is interchangeable with other elements made of expanded material also preferentially adopting the form of a flat layer of regular thickness, but of a different type and/or thicknesses. Each element made of expanded material 16 is associated with a specific type of fluid duct. It should thus be understood that the element made of expanded material 16 will be selected from along the series of elements made of expanded foam associated with the measurement sleeve 1A depending on the type of fluid duct to be equipped. The measurement sleeve 1A is therefore provided with a kit of elements made of expanded material comprising as many elements made of expanded material as there are types of duct to be equipped, both in terms of material from which the duct is made (steel, stainless steel, etc.) and I its dimensions. The role of the element made of expanded material is to adjust the pressure to be applied to the duct via the piston depending of the type of duct.

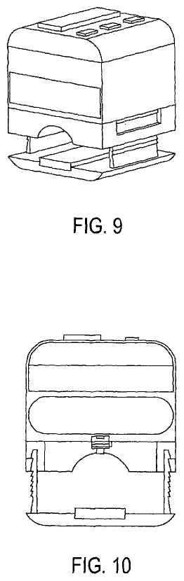

FIGS. 9 and 10 illustrate an alternative embodiment showing the device with a box incorporating the electronic portion without separating the portions. In this exemplary embodiment, the electronic box 17, the cover 6 and the top portion 3 are formed in one piece.

In the examples described previously, the measurement sleeve was illustrated to be mounted on a fluid duct having a circular section. It is evidently understood that the invention is not restricted to such ducts, said sleeve being designed to be employed on fluid ducts with a section other than circular. The shape of the inner walls of the parts 2 and 3 intended to form the accommodating space 7 will then be adapted according to the fluid duct to be equipped.

The invention is described above as an example. It is understood that those skilled in the trade are capable of creating different alternative embodiments of the invention without departing from the framework of the invention.

1. A measurement sleeve for determining the amount of fluid passing through a duct, wherein said sleeve, designed to be fitted around a fluid duct, comprises a first part and a second part interconnected to define an accommodating space for the duct in addition to an electromechanical sensor arranged on one of the parts so as to be applied against the outside wall of the duct, wherein the measurement sleeve comprises calibrated adjustment means for adjusting the accommodating space according to separate predefined diameters so as to apply an appropriate predetermined pressure to the sensor regardless of the dimensions of the duct, with each predefined diameter corresponding to a duct of a specific diameter.

2. The measurement sleeve according to claim 1, wherein the electromechanical sensor is integral with a piston capable of travelling between a position in which said piston has a protruding portion protruding into the accommodating space and a position in which said piston is flush with the inside wall of the part with which it is arranged.

3. The measurement sleeve according to claim 1, wherein the piston is held in the protruding position in the accommodating space before the sleeve is clamped around the duct by means of an element forming a spring.

4. The measurement sleeve according to claim 1, wherein the adjustment means comprise a rack borne by one of the parts, the other part being provided with a lug configured to engage with a notch in the rack, said rack comprising a plurality of notches arranged to define, with the lug engaged, accommodating spaces suitable for receiving respectively a duct of a given diameter while jointly ensuring the application of the same pressure regardless of the diameter of the duct on which the sleeve is mounted.

5. The measurement sleeve according to claim 1, wherein said sleeve comprises means of adjusting the load pressure exerted on the duct by the piston.

6. The measurement sleeve according to claim 4, wherein the means of adjusting the load pressure comprise an interchangeable element made of expanded material, of uniform thickness, designed to be interposed between one of the parts and the fluid duct such that when the measurement sleeve is mounted and clamped on the fluid duct, the piston exerts a pressure adapted to the fluid duct.

7. The measurement sleeve according to claim 1, wherein the sensor is configured to move in a direction perpendicular to the longitudinal axis of the accommodating space.

8. The measurement sleeve according to claim 1, wherein the electromechanical sensor is integral with an electrically conductive element bearing the piston.

9. The measurement sleeve according to claim 1, wherein the sensor is arranged between two wedging elements, with one of the wedging elements forming the piston and each wedging element comprising an electrically conductive contact portion configured to be placed in contact with an electrical contact pin.

10. The measurement sleeve according to claim 9, wherein the electrical conduct pins are accommodated in a third part fixed to the part comprising the electromechanical sensor.

11. The measurement sleeve according to claim 1, wherein the electromechanical sensor is a piezoelectric sensor.

12. Equipment for determining the amount of fluid passing through a duct, comprising a measurement sleeve according to claim 4, comprising a series of interchangeable elements, made of expanded material, of a different type and/or thicknesses.
